(19) United States
(12) Patent Application Publication
(10) Pub. No.: US 2010/0095802 A1
(43) Pub. Date: Apr. 22, 2010

(54) ERROR-PROOFED DOOR HANDLE CABLE END-FITTING

(76) Inventors: Rajesh K. Patel, Oakland, MI (US); Daniel Carl Bejune, Southfield, MI (US)

Correspondence Address: PRICE, HENEVELD, COOPER, DEWITT & LITTON, LLP;FGTL, 695 KENMOOR S.E., P. O. BOX 2567, GRAND RAPIDS, MI, 49501-2567, US

(21) Appl. No.: 12/255,220

(22) Filed: Oct. 21, 2008

(51) Int. Cl. F16C 1/10; B66D 1/28; B23P 11/00

(52) U.S. Cl. 74/502.4; 254/389; 29/457

(57) ABSTRACT

A cable assembly having an elongate cable and a cable fitting having an elongate body with a first end, a second end, and a tubular duct extending therethrough adapted to receive the elongate cable. First and second annular rings extend substantially circumferentially around a portion of the elongate body and define an annular groove therebetween. A circumferential support has a first section that extends from the first annular ring to the first end and a second section that extends from the second annular ring to the second end. An outer circumference of the annular groove is less than an outer circumference of the circumferential support.

### FIELD OF THE INVENTION

The present invention generally relates to a handle cable fitting and more specifically to an error-proofed door handle cable end-fitting that can be used in connection with an inside or outside door handle.

### BACKGROUND OF THE PRESENT INVENTION

Cable fittings are typically installed in a vehicle door and are operably connected to the door handle so that the door maybe opened and closed.

### SUMMARY OF THE INVENTION

One aspect of the present invention includes a fastening assembly for a vehicle for an elongate cable having an elongate body with a first end, a second end, and a tubular duct extending there through. The tubular duct includes a central access. First and second annular rings extend substantially circumferentially around a portion of the elongate body and define an angular groove therebetween. A circumferential support has a first section that extends from the first annular ring to the first end and a second section that extends from the second annular ring to the second end. The radial distance from the central access to the annular groove is less than the radial distance from the central access to the outside surface of the circumferential support. Another aspect of the present invention includes a cable assembly for a vehicle door. An elongate cable is operably connected to one of an inside handle and an outside handle disposed on the vehicle door. A cable fitting has an elongate body with a first end, a second end, and a tubular duct extending therethrough adapted to receive the elongate cable. First and second annular rings extend substantially circumferentially around a portion of the elongate body and define an annular groove therebetween. A circumferential support has a first section that extends from the first annular ring to the first end and a second section that extends from the second annular ring to the second end. An outer circumference of the annular groove is less than an outer circumference of the circumferential support.

Another aspect of the present invention includes a method of making a fastening assembly that operably connects a latching mechanism with a vehicle door handle. An elongate body is formed having a first end and second end. The tubular duct is formed through the elongate body. First and second annular rings are formed that extend substantially circumferentially around a portion of the elongate body. An annular groove is created between the first annular ring and the second annular ring. A first support section is extended from the first annular ring and a second support section is extended from the second annular ring. The outside circumference of one of the first and second support sections is formed larger than the outside circumference of the annular groove.

These and other features, advantages and objects of the present invention will be further understood and appreciated by those skilled in the art upon studying the following specification, claims, and appended drawings.

### BRIEF DESCRIPTION OF THE DRAWINGS

FIG. 1 is a vehicle incorporating the present invention;

FIG. 2 is a partial side elevational view taken at TI of the vehicle door illustrated in FIG. 1;

FIG. 3 is a top perspective view of one embodiment of a cable fitting of the present inventions;

FIG. 4 is a top perspective view of the cable fitting of the present invention in an inside handle cable application;

FIG. 5 is an enlarged view of area V of FIG. 4;

FIG. 6 is the cable fitting of FIG. 5 removed from the handle frame;

FIG. 7 is a side perspective view of a portion of the cable fitting in an outside handle cable application;

FIG. 8 is an enlarged view of area VIII of FIG. 7;

FIG. 9 is the cable fitting of FIG. 8 removed from the handle frame;

FIG. 10 is a side elevational view of the cable fitting engaged with a receiver;

FIG. 11 is a front elevational view of the cable fitting of FIG. 3;

FIG. 12 is a side elevational view of the cable fitting of FIG. 3;

FIG. 13 is a side cross-sectional view of one embodiment of a cable fitting of the present invention taken at line XIII-XIII of FIG. 12;

FIG. 14 is a side cross-sectional view of an alternative embodiment of a cable fitting of the present invention;

FIG. 15 is a top perspective view of another embodiment of a cable fitting of the present invention;

FIG. 16 is a front elevational view of the cable fitting of FIG. 15; and

FIG. 17 is a side elevational view of the cable fitting of FIG. 15.

### DETAILED DESCRIPTION OF PREFERRED EMBODIMENTS

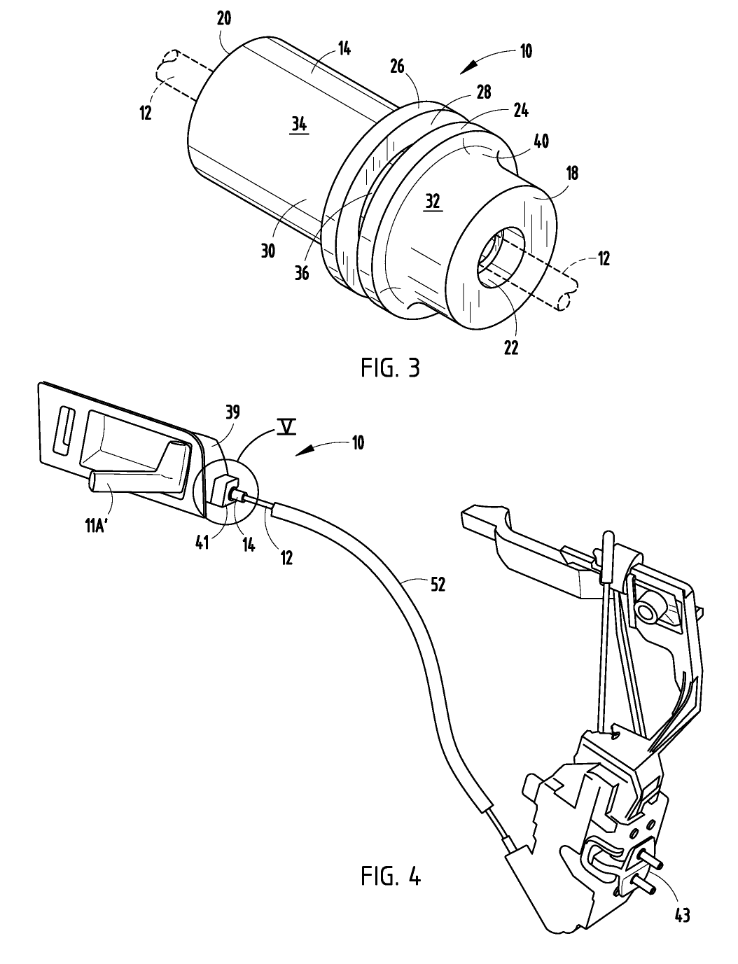

For purposes of description herein the terms “upper,” “lower,” “right,” “left,” “rear,” “front,” “vertical,” “horizontal” and derivatives thereof shall relate to the invention as oriented in FIG. 3. However, it is to be understood that the invention may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

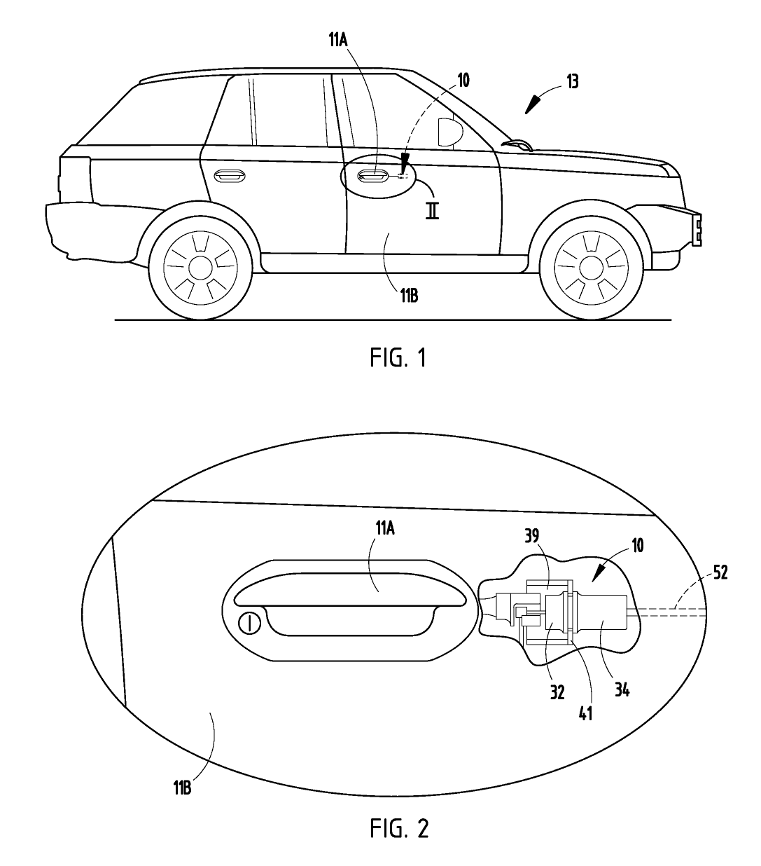

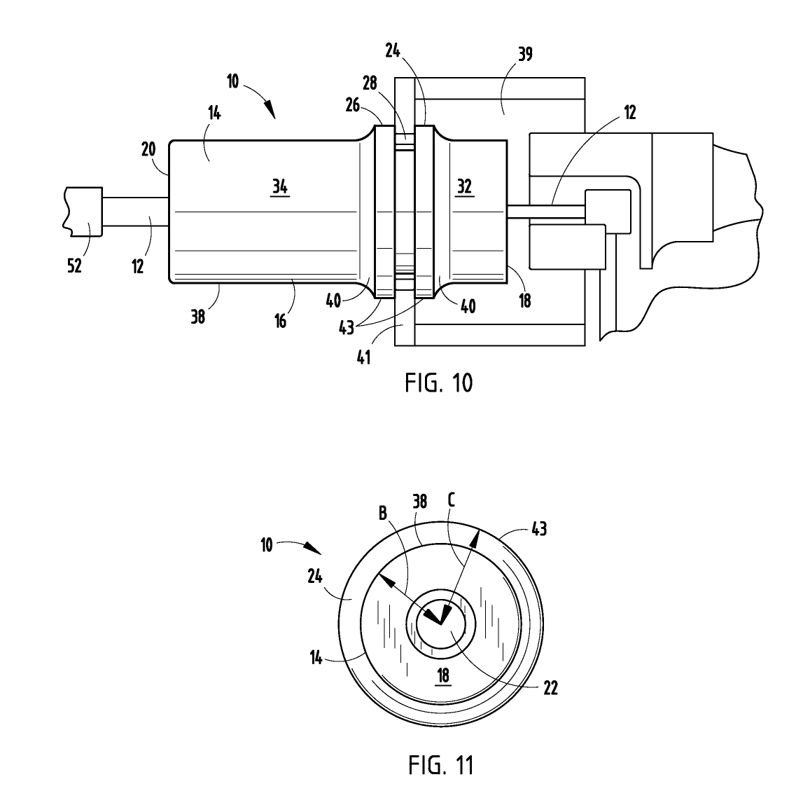

Referring to FIGS. 1-3, the reference numeral 10 generally designates a cable assembly operably connected with a door handle 11A of a door 11B of a vehicle 13. The cable assembly includes an elongate cable 12 and a cable fitting 14 with a first end 18, a second end 20, and a tubular duct 22 extending therethrough adapted to receive the elongate cable 12. First and second annular rings 24, 26 extend substantially circumferentially around a portion of the elongate cable 12 and define an annular groove 28 therebetween. A circumferential support 30 has a first section 32 that extends from the first annular ring 24 to the first end 18 and a second section 34 that extends from the second annular ring 26 to the second end 20. An outer circumference 36 of the annular groove 28 is less than an outside surface 38 (FIGS. 10 and 11) of the circumferential support 30.

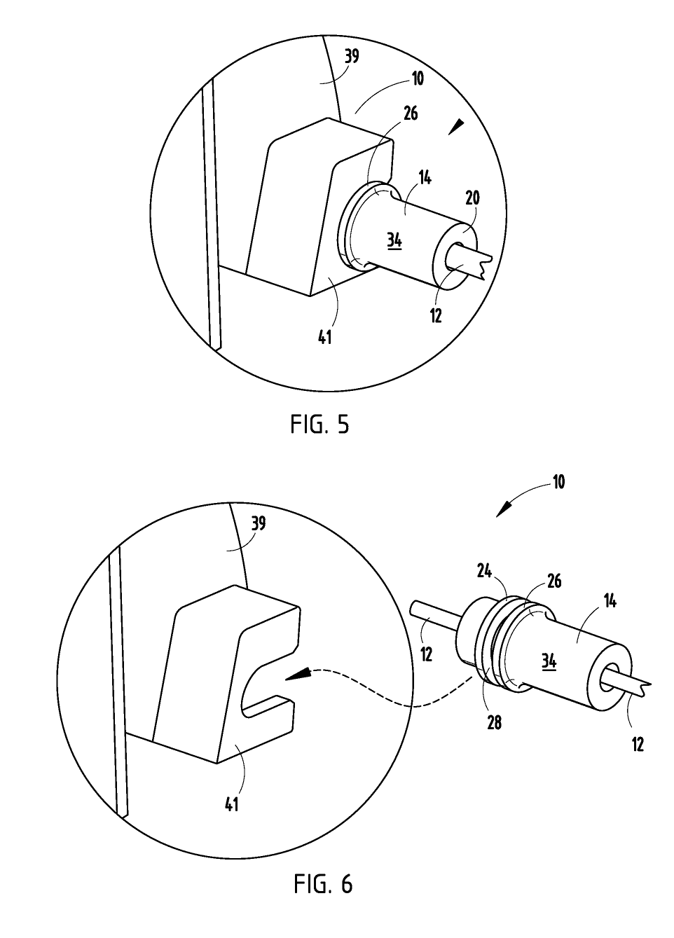

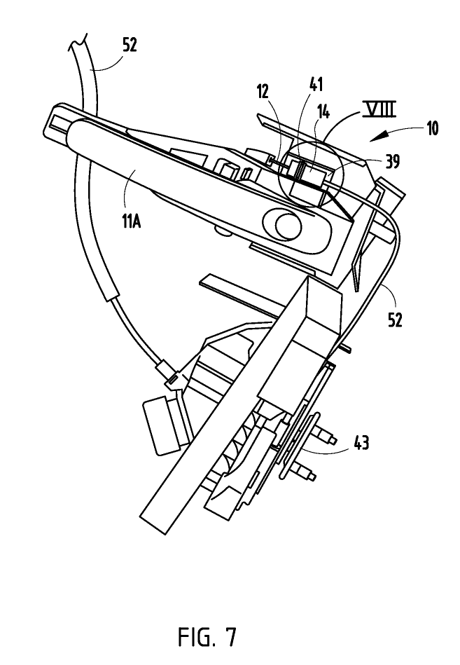

Referring now to FIGS. 2-6, the cable fitting 14 is operably connected to a handle frame 39 that opens the door 11B when the handle 11A is opened by the user. The handle 11A may be an outside door handle 11A (FIG. 7) or an inside door handle 11A′ (FIG. 4). Accordingly, the explanation detailed below with respect to outside handle 11A applies also to inside handle 11A′. The elongate cable 12 has a first end 41 that extends through the cable fitting 14 and a second end that is operably connected to a door latching mechanism 43. The latching mechanism 43 secures the door 11B shut when the door 11B is in the closed position.

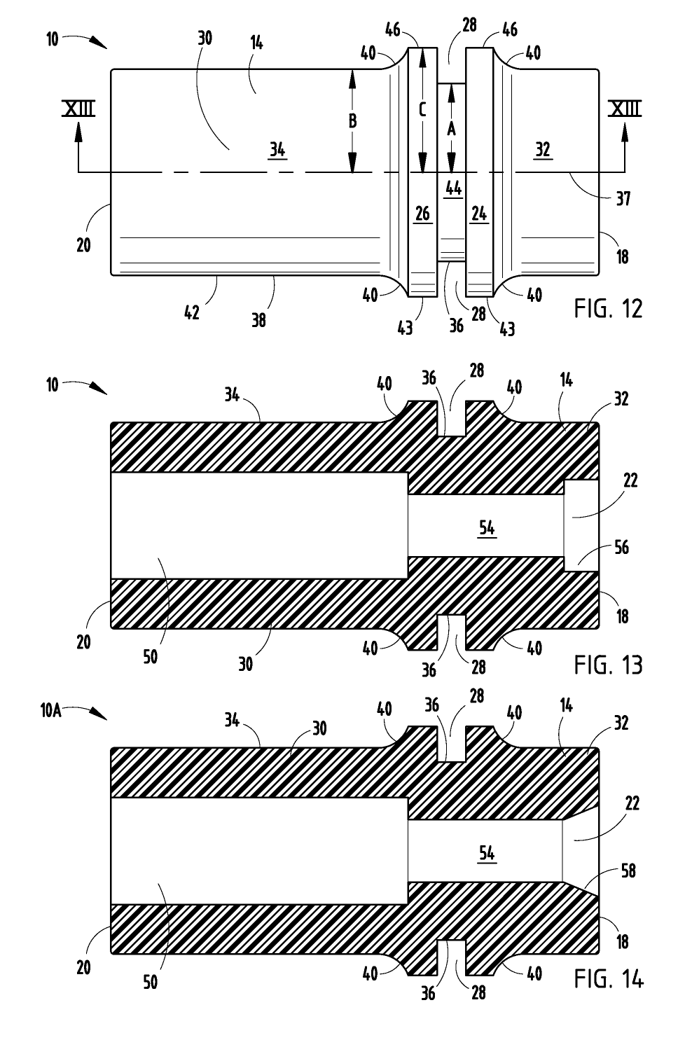

As shown in FIGS. 11 and 12, a central axis 37 extends through the elongate body. The radial distance A that extends from the central axis 37 to the outer circumference 36 of the annular groove 28 is less than the radial distance B from the central axis 37 to the outside surface 38 of the circumferential support 30. Further, the radial distance from the central axis 37 to the outside surface 38 is less than radial distance C from the central axis 37 to an outside surface 43 of the first and second annular rings 24, 26. The outside surfaces 38, 43 maybe smooth, ridged, indented, etc.

Referring now to FIGS. 3 and 10-12, the handle frame 39 includes a U-shaped receiver 41 adapted to engage the annular groove 28 of the cable fitting 14. The cable fitting 14 includes a tapered area 40 that transitions the circumferential support 30 to the first and second annular rings 24, 26. The circumferential support 30 has a smooth round circumference 42. Similarly, the annular groove 28 also has a smooth round circumference 44. The outer circumference 36 of the annular groove 28 is less than the outer circumference 46 of the first and second annular rings 26, 28 or the circumferential support 30.

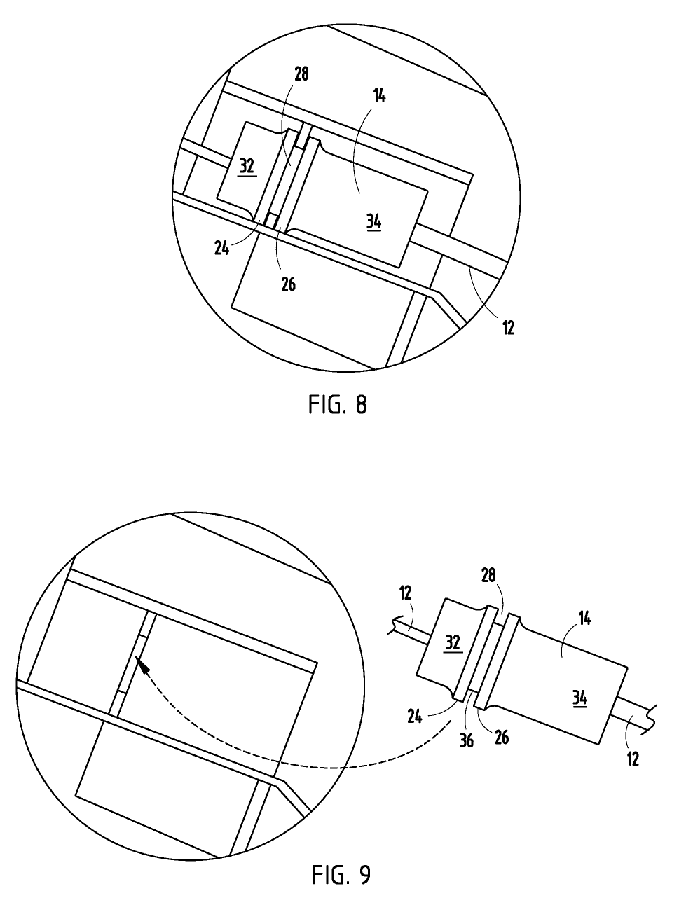

As shown in the embodiment illustrated in FIGS. 7-9, the cable fitting 14 is also adapted for use with the outside handle 11A of the vehicle door 11B (FIGS. 1 and 2). Accordingly, the cable fitting 14 provides exceptional versatility as it can be used in a variety of U-shaped receivers 41 that secure various cable mechanisms in place in a vehicle door 11B and which actuate door latching mechanisms 43 in the door 11B.

As shown in FIGS. 13 and 14, a sheath cavity 50 is located in the second section 34 of the circumferential support 30. The sheath cavity 50 is designed to receive a cable sheath 52 (FIG. 4) but allow the cable 12 to pass through a central portion 54 of the tubular duct 22. Optionally, the cable sheath 52 may not extend into the sheath cavity 50. Additionally, a cable flex cavity 56 is located in the first section 32 of the circumferential support 30. The cable flex cavity 56 can have a variety of shapes including a circumferential side wall cut at a right angle, as shown in FIG. 13 as well as an arcuate, diagonal, tiered, etc. construction. It is also contemplated that a conical cable flex 58 cavity as shown in the cable assembly 10A in FIG. 14 can be used. It is also contemplated that the cable sheath cavity 50 could be in the first section 32 of the circumferential support 30 and the cable flex cavity 56 could be in the second section 34 of the circumferential support 30.

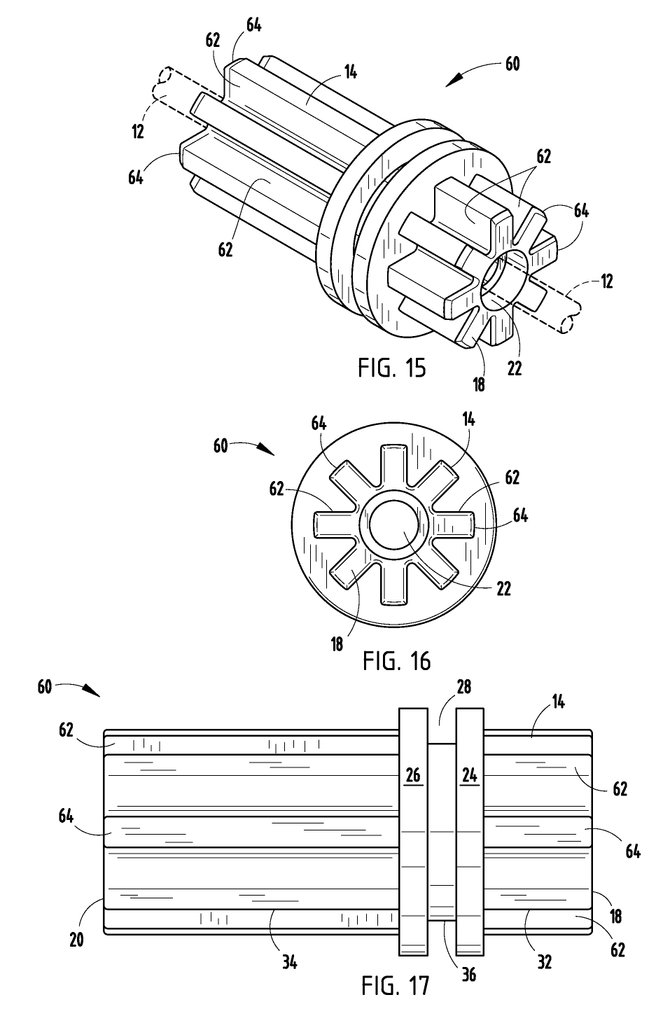

Referring now to FIGS. 15-17, the illustrated embodiment shows a cable fitting 60 having an elongate body 62 with a plurality of ribs 64 extending longitudinally along the circumferential support 30. It will be understood by one having ordinary skill in the art that reference numerals that are the same between the first embodiment and other embodiments denote similar structural elements. The plurality of ribs 64 could be any number of ribs although the illustrated embodiment includes eight. The plurality of ribs 64 are believed to add strength to the cable fitting 60.

It is contemplated that the cable fitting 14 could be used with a variety of door systems, not just the vehicle handle discussed above. In addition, it is contemplated that the cable fitting 14 could be used with either an inside handle, outside handle, or both inside and outside handles of a door assembly. Further, it is contemplated that the outer circumference of the cable fitting 14 on either side of the annular rings 26, 28 could have other various shapes.

The design of the cable fitting 14 prevents a partially secured connection because the U-shaped receiver 41 (FIG. 10) cannot receive the cable fitting 14 except at the annular groove 28. In addition, because the cable fitting 14 can only be received by the U-shaped receiver 41 at the annular groove 28, the elongate cable 12 is not subject to preloading as could happen with conventional designs as a result of improper installation. Further, the cable fitting 14 of the present invention eliminates the possibility of slack build up on the latching mechanism 43 (FIGS. 4 and 7) which can cause various failures including child lock malfunction.

The above description is considered that of the illustrated embodiments only. Modifications of the invention will occur to those skilled in the art and to those who make or use the invention. Therefore, it is understood that the embodiments showing the drawings and described above are merely for illustrative purposes and not intended to limit the scope of the invention, which is defined by the following claims as interpreted according to the principles of patent law, including the doctrine of equivalents.

We claim:

1. A fastening assembly for an elongate cable comprising:
an elongate body having a first end, a second end and a tubular duct extending therethrough, wherein the tubular duct includes a central axis;
first and second annular rings extending substantially circumferentially around a portion of the elongate body and defining an annular groove therebetween; and
a circumferential support having a first section that extends from the first annular ring to the first end and a second section that extends from the second annular ring to the second end wherein the radial distance from the central axis to the annular groove is less than the radial distance from the central axis to the outside surface of the circumferential support.

2. The fastening assembly of claim 1, wherein:
the first and second sections include a smooth round circumference.

3. The fastening assembly of claim 1, wherein:
the first and second sections include a plurality of ribs extending longitudinally along the circumferential support.

4. The fastening assembly of claim 1, wherein:
the radial distance from the central axis to the outside surface of the circumferential support is less than the radial distance from the central axis to the outside surface of the first and second annular rings.

5. The fastening assembly of claim 1, wherein:
one of the first portion and second section includes a sheath cavity.

6. The fastening assembly of claim 5, wherein:
the other of the first portion and second section includes a cable flex cavity.

7. The fastening assembly of claim 6, wherein:
the cable flex cavity widens conically outward from the tubular cavity.

8. The fastening assembly of claim 6, wherein:
the cable flex cavity includes a circumferential sidewall.

9. A cable assembly for a vehicle door comprising:
an elongate cable operably connected to one of an inside handle and an outside handle disposed on the vehicle door;
a cable fitting having an elongate body with a first end, a second end and a tubular duct extending therethrough adapted to receive the elongate cable;
first and second annular rings extending substantially circumferentially around a portion of the elongate body and defining an annular groove therebetween, and
a circumferential support having a first section that extends from the first annular ring to the first end and a second section that extends from the second annular ring to the second end wherein an outer circumference of the annular groove is less than an outer circumference of the circumferential support.

10. The cable assembly of claim 9, wherein:
the first and second portions include a smooth round circumference.

11. The cable assembly of claim 9, wherein:
the first and second sections include a plurality of ribs extending longitudinally along the circumferential support.

12. The cable assembly of claim 9, wherein:
the distance from the central axis to the outside surface of the circumferential support is less than the distance from the central axis to the outside surface of the first and second annular rings.

13. The cable assembly of claim 9, wherein:
one of the first portion and second section includes a sheath cavity.

14. The cable assembly of claim 13, wherein:
the other of the first portion and second section includes a cable flex cavity.

15. The cable assembly of claim 14, wherein:
the cable flex cavity widens conically outward from the tubular cavity.

16. The cable assembly of claim 14, wherein:
the cable flex cavity includes a circumferential sidewall.

17. A method of making a fastening assembly that operably connects a latching mechanism with a vehicle door handle, the method comprising:
forming an elongate body having first and second ends;
forming a tubular duct through the elongate body;
forming first and second annular rings that extend substantially circumferentially around a portion of the elongate body;
creating an annular groove between the first annular ring and second annular ring;
extending a first support section from the first annular ring;
extending a second support section from the first annular ring; and
forming the outside circumference of one of the first and second support sections larger than the outside circumference of the annular groove.

18. The method of claim 17, further comprising:
forming the outside circumference of the first and second annular rings larger than the outside circumference of the first and second support sections.

19. The method of claim 18, further comprising:
forming a plurality of ribs that extend longitudinally along the first and second support sections.

20. The method of claim 18, further comprising:
forming a cable flex cavity in one of the first and second support sections.
